(19) United States
(12) Patent Application Publication
(10) Pub. No.: US 2021/0126777 A1
(43) Pub. Date: Apr. 29, 2021

(54) SYSTEMS AND METHODS FOR PROVIDING SECURE DATA ACCESS CONTROL USING DISTRIBUTED LEDGERS

(71) Applicant: Daniel Mash, Scunthorpe (GB)

(72) Inventor: Daniel Mash, Scunthorpe (GB)

(21) Appl. No.: 17/081,201

(22) Filed: Oct. 27, 2020

Related U.S. Application Data
(60) Provisional application No. 62/927,138, filed on Oct. 29, 2019.

(30) Foreign Application Priority Data
Oct. 29, 2019 (GB) 62927138
Oct. 27, 2020 (GB) 2017056.9

(51) Int. Cl. H04L 9/08; H04L 12/26; H04L 9/32

(52) U.S. Cl. CPC H04L 9/0825; H04L 43/10; H04L 9/06; H04L 9/3215; H04L 2209/38; H04L 9/088

(57) ABSTRACT

Techniques for providing secure data access control mechanisms using distributed ledgers are disclosed. The method includes receiving information related to customers via a secure application programming interface and encrypting the received information using a cryptographic algorithm. The encrypted information is transmitted to a cloud service platform and thereafter categorized into sensitive and non-sensitive data. Further, the cloud service platform is configured to record the encrypted non-sensitive data in a public blockchain and encrypted sensitive data in a private blockchain by executing a smart contract. These blockchain transactions are accessible by the customers and the vendors. Furthermore, a communication protocol is established between the customers and the vendors. The smart contract is executed based on an approval from one of the one or more customers to allow one of the vendors to view at least a sub-set of the sensitive data related to that customer.

### CROSS-REFERENCE TO RELATED APPLICATIONS

This application claims the benefit of U.S. Provisional Patent Application Ser. No. 62/927,138, entitled “System and method for implementing artificial intelligence models and customer models for smart contracts, chaincode, or logic using distributed ledgers”, filed Oct. 29, 2019, UKIPO Application Ser. No. GB1915633.0, entitled “System and method for implementing artificial intelligence models and customer models for smart contracts, chaincode, or logic using distributed ledgers”, filed Oct. 29, 2019, and UKIPO Application Ser. No. GB2017056.9, entitled “Systems and methods for providing secure data access control using distributed ledgers”, filed Oct. 27, 2020, which is incorporated herein in its entirety.

### TECHNICAL FIELD

The present disclosure is related to the field of information security. More particularly, the present disclosure is related to methods, systems, and techniques for using smart contracts in distributed ledgers to protect customer information.

### BACKGROUND

In a highly connected world where almost every business is dependent on public and personal information related to customers for its functioning, information security has become an important aspect to be taken care of by customers as well as businesses. While conventional brick and mortar businesses invested heavily in physical security at their offices and warehouses, modern businesses that are more reliant on the internet have to take care of both physical security as well as virtual (digital information) security to protect their assets and interests. Similarly, customers who play the most important role in the smooth functioning of any business need to take care of their information from being shared on the internet without any restriction.

Using customer information to provide tailor-made services has become an accepted norm in the information age. Almost all businesses rely on customer data to understand the interests of each customer to provide relevant services. Using customer meta-data, businesses can identify customer interests and requirements to target specific customers and provide personalised services to the right customer. For customers, the possibility of receiving service offerings that are not at all relevant to their interests is significantly reduced. Businesses can optimise their quality of service if they are aware of the interests of a customer. At the same time, it may not be ethical or legal for businesses to hold personal data of customers who do not wish to share their information. While it is mutually beneficial for businesses as well as customers to share personal information among each other in many scenarios, several challenges have emerged in recent times wherein information is shared without authorisation leading to issues such as violation of privacy, spamming, compliance issues with respect to data protection laws, and the like.

Another prominent issue related to information security is the unavailability of a centralized platform that is secure as well as easy to understand for individuals who are connected to the digital ecosystem. Most individuals create a digital footprint while using various services offline and online. Personal information or breadcrumbs of personal information is exposed even by the most diligent users. Data collection services may gather and collate this information to their advantage. Furthermore, data leaks from major companies due to weak cybersecurity systems have led to the availability of personal information for a price on the internet as well.

While some businesses may knowingly access personal information without customer authorization, others come in possession of them due to the customer's unfamiliarity with data sharing mechanisms. While it is obvious that customers may be concerned with unauthorized use of their information by businesses, the same holds true for most businesses as well. Most businesses are concerned with storing information related to customers without authorization since it may be illegal for them to do so. There are several laws and regulations that bar businesses from storing or using personal information without the consent of the customers.

The technical problems related to information security such as securely storing customer information with a strict data access control mechanism, providing a mechanism for customers to monitor who can access their information, providing a mechanism for customers to authorize certain businesses to access some/all of their information, providing a mechanism for businesses to request certain information for customers based on their requirements, providing a digital platform to store information related to data reads/writes/modifications that cannot be corrupted, and the like, are being addressed in this disclosure.

The present disclosure addresses the abovementioned technical problems to provide a solution for customers by giving them complete control over their information. Furthermore, the present disclosure provides businesses with a solution to securely access customer information while strictly adhering to data protection laws.

### SUMMARY

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments described herein discloses a system, method and a non-transitory medium storing instructions to execute a technique for providing secure data access control mechanisms using blockchains. The method includes the step of receiving information related to customers via a secure application programming interface and encrypting the received information using a cryptographic algorithm. The encrypted information is transmitted to a cloud service platform and thereafter categorized into sensitive and non-sensitive data. Further, the cloud service platform is configured to record the encrypted non-sensitive data in a public blockchain and encrypted sensitive data in a private blockchain by executing a smart contract. These blockchain transactions are accessible by the customers and the vendors. Furthermore, a communication protocol is established between the customers and the vendors. The smart contract is executed based on an approval from one of the one customers to allow one of the vendors to view at least a sub-set of the sensitive data related to that customer.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a block diagram of the architecture of a secure data access management platform according to the embodiments of the present disclosure;

FIG. 2 is an information flow diagram depicting various stakeholders of the secure data access management platform according to the embodiments of the present disclosure;

FIG. 3 is an exemplary flowchart depicting the functions related to securely storing customer information according to the embodiments of the present disclosure;

FIG. 4 is an exemplary flow chart depicting functions related to securely accessing customer information according to the embodiments of the present disclosure;

FIG. 5 is an exemplary illustration of a customer view of their information according to the embodiments of the present disclosure;

FIG. 6 is an exemplary illustration of a vendor's view of a customer's information according to the embodiment of the present disclosure;

FIG. 7 is an exemplary illustration of a vendor requesting certain customer information according to the embodiments of the present disclosure;

FIG. 8 is an exemplary illustration of an updated view from a vendor's perspective after a customer provides access to requested information according to the embodiments of the present disclosure;

FIG. 9 is an example flow diagram of a method for providing secure data access control mechanism using blockchains according to the embodiments of the present disclosure;

FIG. 10 is a block diagram of an example machine-readable storage medium storing instructions for providing secure data access control mechanism using blockchains according to the embodiments of the present disclosure;

The drawings described herein are for illustration purposes only and are not intended to limit the scope of the present subject matter in any way.

### DETAILED DESCRIPTION

Embodiments described herein discloses a computer-implemented method and associated systems for providing secure data access control mechanism using blockchains. The method may be executed by a processor storing one or more instructions. The solution starts with the secure data access management platform (hereinafter referred to as platform) receiving information related to one or more customers via a secure application programming interface. Herein, a customer may input private as well as public information related to the customer. Some of this information may be sensitive and private in nature while others may not be as sensitive. The customer may be allowed to input the information via a secure application programming interface (API). Upon receiving the information, the platform encrypts the received information using a cryptographic algorithm and securely transmits the encrypted information to a cloud service platform. The term “cloud platform” and “cloud service platform” may be used interchangeably throughout this document. It may be noted that the usage does not restrict the scope of the present disclosure. In one example, the transmission of the data may be end-to-end encrypted as well. Further, the platform categorizes the encrypted information (now stored in the cloud platform) into sensitive and non-sensitive data. Thereafter, the platform configures the cloud service platform to record the encrypted non-sensitive data in a public blockchain as transactions that are accessible to one or more customers and one or more vendors. It may be noted that such a transaction written in a public blockchain may be accessible to all due to the inherent design of public blockchains. A blockchain transaction ID may be generated while writing the non-sensitive data to the public blockchain. In one example, the cloud service platform may be configured to write the cloud platform's transaction ID related to the customer information in the public blockchain. Upon writing this data to the public blockchain, a blockchain transaction ID is generated. Upon writing the non-sensitive data (such as the cloud platform's transaction ID) to the public blockchain, the platform proceeds to write the sensitive private data to a private blockchain. Herein, the platform uses smart contracts to encapsulate the sensitive data to provide further protection to the sensitive data. Hence, sensitive customer information may be stored in a private blockchain using a smart contract to provide enhanced protection against a plurality of vulnerabilities with respect to data access and manipulation. The platform configures the cloud service platform to record the encrypted sensitive data in a private blockchain as transactions that are accessible by the one or more customers and the one or more vendors by executing a smart contract. Herein, sensitive data may include private information related to the customer such as customer name, email, phone number, fax number, social media profile details, social security numbers, driving license number, passport details, tax details, date of birth, gender, date of birth, marital status, purchase history, bank account details, credit score, occupation, address, education, and the like. It may be noted that public/private information may vary for a public personality and a private individual. Laws of many countries distinguish privacy-related information with respect to public personalities and private individuals. The terms and examples used herein are to be read in the context of the technical solution provided herein.

Further, the platform provides a mechanism for the customers and the vendors to establish a communication protocol between them for receiving/sending requests related to information sharing. This step may be referred to as the synchronization step wherein a handshake takes place between the customer and the vendor. In one example, the connected API may generate QR codes or other related representations to allow the customers and the vendors to synchronize. Once the synchronization step is performed, the customer may be able to push information to the vendor with/without a request from the vendor's side. Similarly, the vendor may be able to receive information from the customer with/without a request being sent for the same from the vendor's side. In one example, the customer synchronized with the vendor and may decide to send specific information to the vendor. Once the synchronization step is performed, the customer may voluntarily push this information to the vendor. For example, the vendor may be a bank and the customer may be an individual who wishes to open an account in the bank. Once the bank and the customer synchronize using the platform, the customer may voluntarily send private sensitive information such as customer name, date of birth, address, email, and phone number to the bank for the purpose of opening an account. As the bank and customer are synchronized, the bank may readily identify the user from whom the data is received and may accept the information.

In another example, the vendor may be a supermarket and they want to access the phone number of the customer to send them customized deals and offers. In this scenario, once the customer and the vendor (supermarket) synchronize, the vendor may send a request to the customer to view the phone number. The customer may allow or deny this request depending on their choice. In both the abovementioned scenarios, the private information stored in the private blockchain is accessed by executing a smart contract. The customer may have complete control over the data access and may execute the smart contract to toggle the information visibility for different vendors. When a customer wishes to push information to a vendor voluntarily or when a customer wishes to push information to a vendor based on a vendor's request, the platform allows the customer to provide an approval which in turn executes a smart contract to toggle visibility. In some examples, the customer may want to share all of the data stored in the private blockchain and in some cases, the customer may want to share only a subset of data stored in the private blockchain. In both scenarios, the customer will have control over the visibility and access permissions related to their information.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

In the present disclosure, the term “cloud platform” or “cloud service platform” may refer to any cloud computing service that provides a platform allowing businesses to develop, run, and manage applications in a cloud without the complexity of building and maintaining the infrastructure typically associated with developing and launching an app. The term public blockchain refers to a public distributed ledger that has absolutely no access restrictions. Anyone with an Internet connection can send transactions to it as well as become a validator (i.e., participate in the execution of a consensus protocol).

The term private blockchain refers to a permissioned blockchain wherein one cannot join it unless invited by the network administrators. Participant and validator access is restricted. Since the platform disclosed herein uses a combination of the public blockchain and a private blockchain, it may be said that the solution encompasses the use of a hybrid blockchain which is a mix of public blockchain as well as private blockchain.

Furthermore, the term smart contract referred in the document refers to a self-enforcing agreement embedded in computer code managed by a blockchain. The code contains a set of rules under which the parties of that smart contract agree to interact with each other. If and when the predefined rules are met, the agreement is automatically enforced. Smart contracts provide mechanisms for efficiently managing tokenized assets and access rights between two or more parties. One can think of it as a cryptographic box that unlocks value or access, if and when specific predefined conditions are met. The underlying values and access rights they manage are stored on a blockchain, which is a transparent, shared ledger, where they are protected from deletion, tampering, and revision. Smart contracts, therefore, provide a public and verifiable way to embed governance rules and business logic in code, which can be audited and enforced by the majority consensus of a P2P network.

The present disclosure makes use of the advantages of public blockchains, private blockchains and smart contracts to provide a secure data access management platform that allows businesses as well as customers to store, share, and manage information securely. The present disclosure uses the most advanced and modern security features by taking advantage of the inherently secure design and features of blockchain technology.

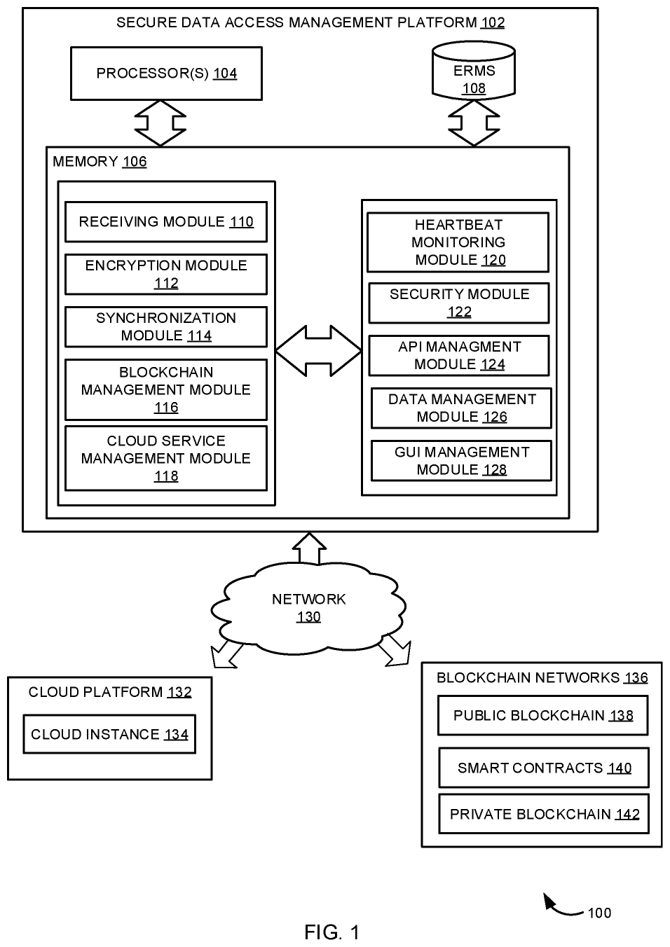

Referring to the figures, FIG. 1 is a block diagram 100 of the secure data access management platform 102 connected to a cloud platform 132 and a blockchain network 136 via a network 130. As shown in FIG. 1, the secure data access management platform 102 may include processor(s) 104 and memory 106 that are communicatively coupled to each other. Further, the personnel evaluation system 102 may include an enterprise repository management system (ERMS) 108 that may be communicatively connected to the memory 106. Furthermore, as shown in FIG. 1, memory 106 may include a receiving module 110, an encryption module 112, a synchronization module 114, a blockchain management module 116, a cloud service management module 118, a heartbeat monitoring module 120, a security module 122, an Application Programming Interface (API) management module 124, a data management module 126, and a GUI management module 128. The cloud platform 132 may have one or more cloud instances 134. The blockchain network 136 may include a public blockchain 138, a private blockchain 142, and related smart contract 140.

Components of the secure data access management platform 102 may be any combination of hardware and programming to implement the functionalities described herein. In some implementations, the programming may be processor 104 executable instructions stored on a non-transitory machine-readable storage medium (e.g., memory 106), and the hardware may include at least one processing resource to retrieve and/or execute those instructions. Processor(s) 104 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) 104 thus may also include the functionality to encode messages and/or data or information. Processor(s) 104 may include, among other things, a clock, an arithmetic logic unit (ALU), and logic gates configured to support the operation of processor(s) 104. Further, the processor(s) 104 may include functionality to execute one or more software programs, which may be stored in the memory 106 or otherwise accessible to processor(s) 104.

Memory 106, may store any number of pieces of information, and data, used by the system to implement the functions of the system. The memory 106 may include, for example, volatile memory and/or non-volatile memory. Examples of volatile memory may include but are not limited to volatile random-access memory (RAM). The non-volatile memory may additionally or alternatively comprise an electrically erasable programmable read-only memory (EEPROM), flash memory, hard drive, and the like. Some examples of volatile memory include, but are not limited to, dynamic RAM, static RAM, and the like. Some example of the non-volatile memory includes, but are not limited to, hard disks, magnetic tapes, optical disks, programmable read-only memory, erasable programmable read-only memory, electrically erasable programmable read-only memory, flash memory, and the like. Memory 106 may be configured to store information, data, applications, instructions, or the like for enabling the system to carry out various functions in accordance with various example embodiments. Additionally, or alternatively, the memory 106 may be configured to store instructions which when executed by processor(s) 104 cause the threat detection and recommendation system 102 to behave in a manner as described in various embodiments.

In one implementation, the network 130 may be a wireless network, a wired network, or a combination thereof. Network 130 may be implemented as one of the several types of networks, such as intranet, local area network (LAN), wide area network (WAN), the internet, and the like. Network 130 may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 130 may include a variety of network devices, including routers, bridges, servers, computing devices, storage devices, and the like.

During the operation, the receiving module 110 may receive information from the customer via an application programming interface (API). The encryption module 112 may encrypt the received information using a cryptographic algorithm. The synchronization module 114 takes care of the handshakes between the customer and the vendors to allow reception or transmission of information among each other using blockchains. The blockchain management module 116 manages communication between the platform 102, the cloud platform 132 and the blockchain network 136. It is responsible for configuring the cloud platform 132 to read/write information to/from the blockchain along with the cloud service management module 118. The blockchain management module 116 and the cloud service management module 118 work together for allowing the platform 102 to provide secure data access control. These modules together allow the platform 102 to configure the cloud platform to communicate in certain ways with the blockchain network 136. Transactions between the cloud platform 132 and the public blockchain 138 and the private blockchain 142 are managed by these modules. Furthermore, execution of the smart contracts 140 and toggling data view/access controls are also primarily managed by these modules. The heartbeat monitoring module 120 checks for active connection between the platform and the blockchain and the cloud platform and the blockchain. The security module 122 is responsible for managing various subsets of information related to the customer that is to be shared with vendors of different categories. The customer may be able to define visibility for a specific set of data for a specific set of vendors in advance to make access grants easy and straight forward. For example, the customer may define a subset of data specifically for vendors in the category of banks and another subset for vendors in the category of hospitals. When the customer connects with a bank, the security module 122 takes a note of the same and allows them access to the subset of data defined for banks. If the vendors request more information or if the customer wishes to provide more information, they may execute the smart contract to modify the visibility as well. The API management module 124 is responsible for the communication of data among services using different APIs along with the data management module 126. The data management module 126 may be responsible for categorizing information into sensitive and non-sensitive data as well. The Graphical User Interface (GUI) module 128 may be support visual representation of various operations via software applications having a user interface accessible to vendors and customers via a plurality of electronic devices.

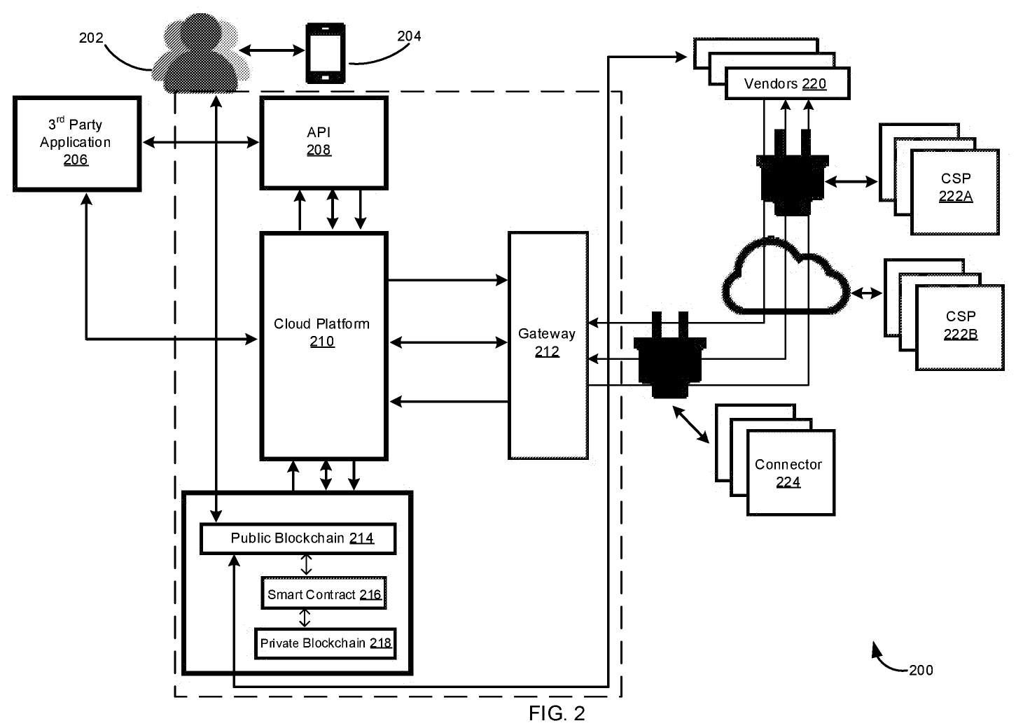

FIG. 2 is an information flow diagram 200 depicting various stakeholders of the secure data access management platform. Herein, the customers 202 may connect to the platform via an electronic device 204. Exemplary electronic devices may include personal computers, laptops, tablet computers, smartphones, wearable computers, phablets, and the like. The electronic device may be capable of running an operating system on top of which supporting software application to access the platform may be installed. Exemplary operating systems may include Microsoft Windows®, Linux, macOS®, Android™, IOS®, and the like. The API 208 may access the cloud platform 132 to send or receive data in different forms. 3^{rd} party application 206 may be used to access the cloud platform 132 as well. The public blockchain 138 may be accessible by the cloud platform 132, the user 202 and vendors 220 without any authorisation. The smart contracts 140 and private blockchain 142 may be accessed by the users via the cloud platform 132 to toggle data access permission. The cloud platform 132 may be accessed by the vendors 220 via a gateway 212. Examples of gateways include Customer Relationship Management (CRM) services used by vendors to access and manage customer information via cloud platforms 210. The vendors 220 may use connectors 224 to access the gateways 212 and the vendors may further use other cloud service providers (CSPs) such as 222A and 222B for their operations. The vendors 220 and the user 202 may access the public blockchain 214, private blockchain 218 and smart contracts 216 (executing smart contracts or request for triggering execution) directly or via cloud platform 210. Different arrows depict communication links representing various functions such as handshakes, data requests, data transmission, and the like. The components of the present solution that are managed by the secure data access management platform 102 are marked within a dotted rectangular block.

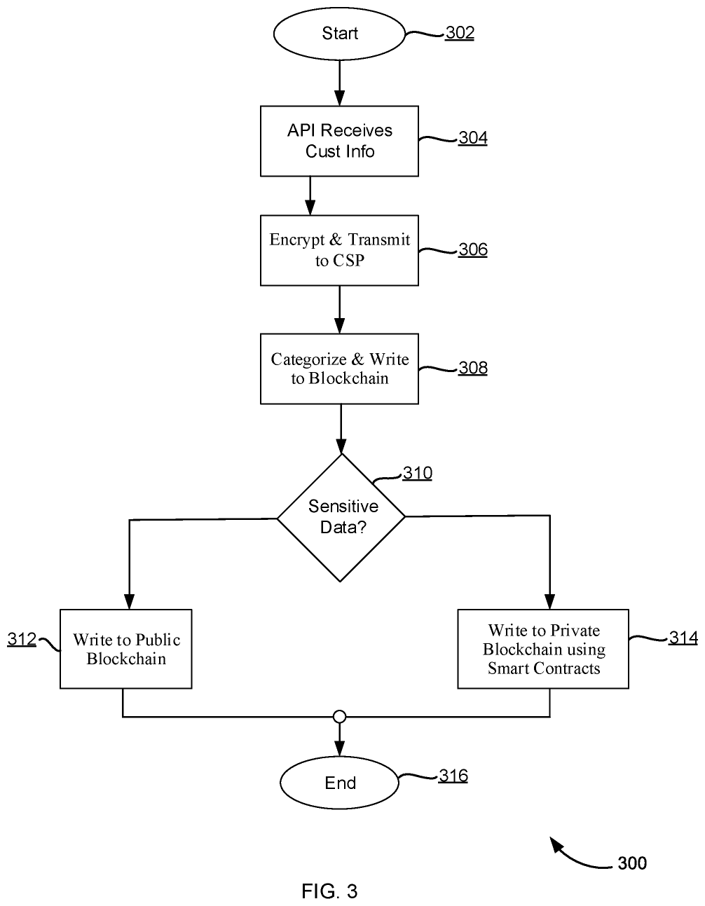

FIG. 3 is an exemplary flowchart 300 depicting the functions related to securely storing customer information using the secure data access management platform 102. The process starts at 302 and proceeds to 304 wherein the API receives customer information via an electronic device. At 306, the platform encrypts and transmits the received information to a cloud service platform. At 308, the platform categorizes the information into sensitive data and non-sensitive data and initiates write to a blockchain network. At 310, if the data is non-sensitive, the process moves to 312 wherein the data is recorded in a public blockchain. If the data is sensitive the process moves to 314 wherein the data is recorded in a private blockchain using smart contracts and the process ends at 316.

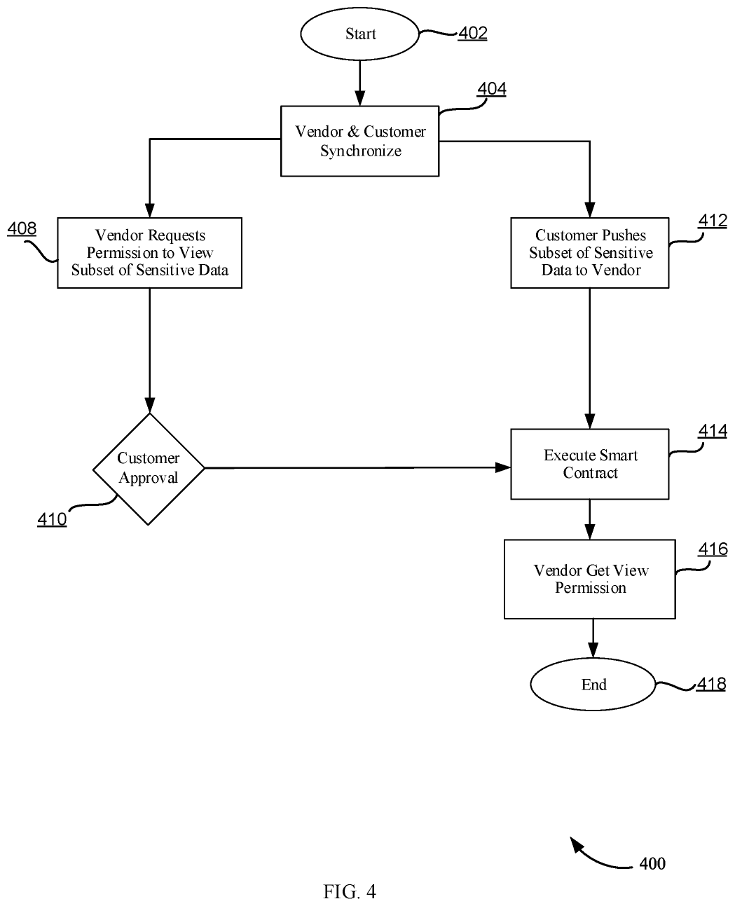

FIG. 4 is an exemplary flow chart 400 depicting functions related to securely accessing customer information using the secure data access management platform 102. The process starts at 402 and proceeds to 404 wherein the customer and vendor synchronize using handshakes. Thereafter, if the vendor requests the customer to view sensitive data (including a partial or full set of data) at 406, approval is sought from the customer at 408. If the customer approves the request for access, the process moves to 412 wherein execution of smart contract takes place and the vendor gets permission to view data at 414. If approval is not provided at 408, the process moves to 416 and ends. Alternatively, if the customer voluntarily pushes data to the vendor at 410, the process moves to 412 and executes the smart contract and thereafter to 414 wherein the vendor gets view permission. The process ends at step 418.

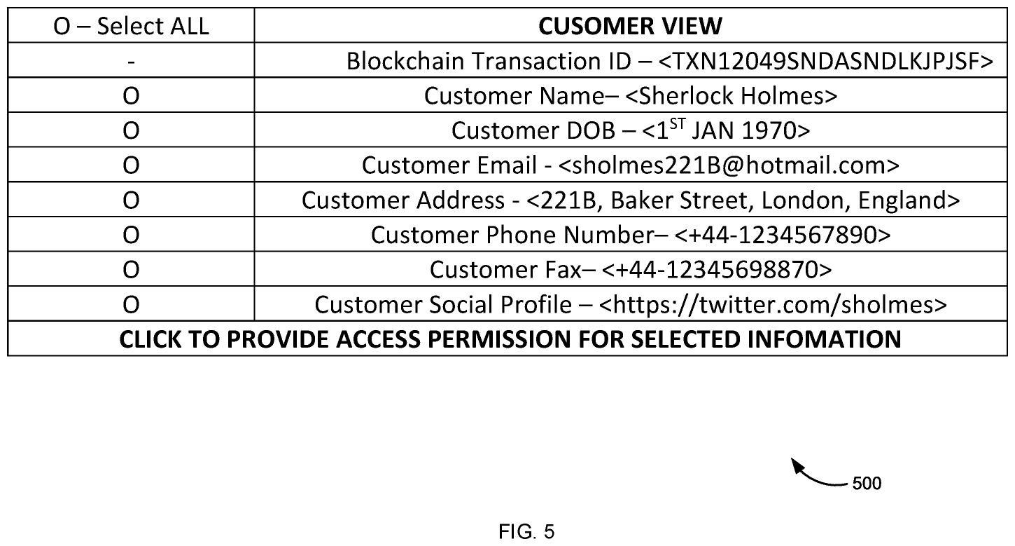

FIG. 5 is an exemplary illustration 500 of a customer view of their information depicted in a table. Herein, the exemplary customer Mr. Sherlock Holmes has provided a set of data to the secure data access management platform via a supporting application. The data stored includes name, date of birth, email, address, phone number, fax, and a social media profile link. The customer may be provided an option via the UI of the supported software application to provide this information. In one example, the customer may be on-boarded to the platform and associated services via a setup wizard supported by the GUI management module 128. Once the customer enters these details, they are encrypted and transmitted to a cloud platform. The information is categorized into sensitive data and non-sensitive data. Simultaneously, the cloud platform may be configured to write a cloud platform's ID related to the customer to a public blockchain. A blockchain transaction ID is received that may be accessible publically when the cloud platform ID related to the customer is stored in the public blockchain.

The blockchain transaction ID may be an example of non-sensitive data that may be accessed by everyone without compromising the privacy of the customer. Further, the sensitive data may be stored in a private blockchain wherein the sensitive data is wrapped using a smart contract. The sensitive data recorded in the private blockchain may be accessed by using a private key. This technique makes sure that the private/sensitive data is securely stored in the private blockchain backed by smart contracts thereby making the data virtually untouchable by an intruder or a hacker. Furthermore, the platform provides options for the customer to define various subsets of data specific for different categories of vendors. The security module allows customers to pre-define multiple subsets of data for specific vendor types. For example, Mr. Holmes may create a subset wherein information such as name, address, email, and phone number can be accessed to vendor type “bank” and “hospital” while another subset for vendor type “cinema” may only allow access to information such as name and email. Herein, smart contracts may be executed to change access settings as and when defined by the security module. Furthermore, the customer (Mr. Holmes) may be able to allow approve vendor requests via the platform for providing access to one or more sensitive information. The customer may voluntarily push one or more sensitive data to a vendor without receiving any request if the customer wants that as well (it may be noted that defining subsets for specific vendor types may also fall under this category of voluntary information declaration).

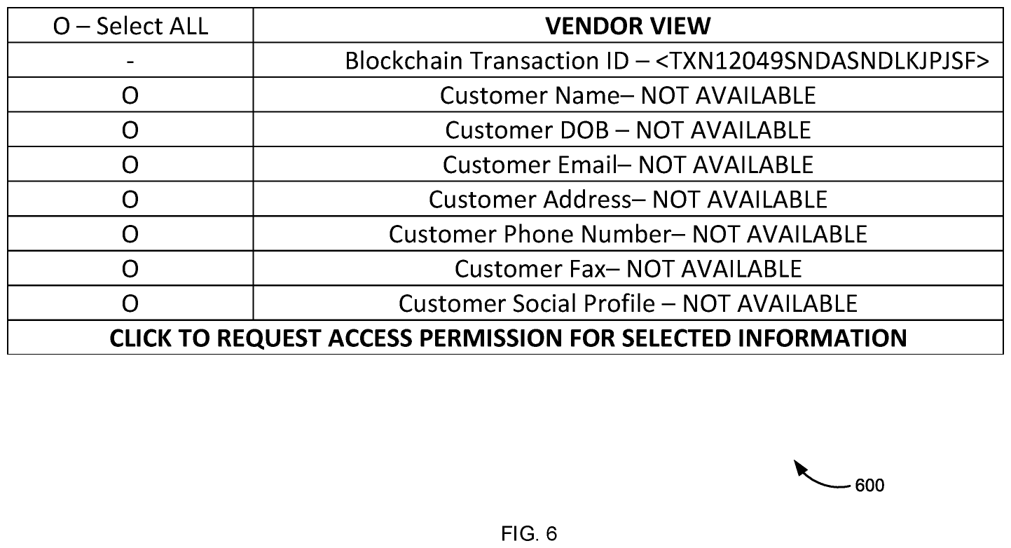

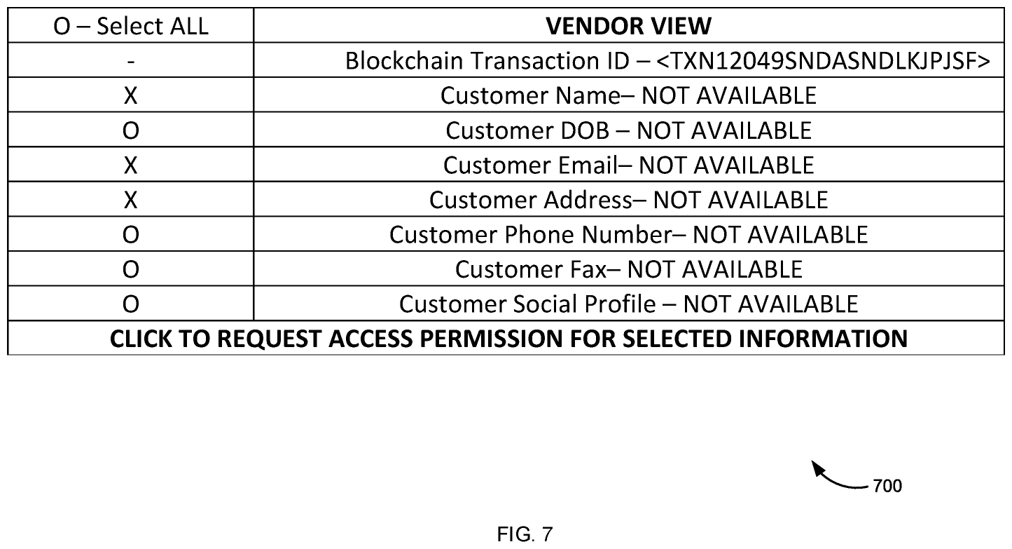

FIG. 6 is an exemplary illustration 600 of a vendor's view of a customer's information. The illustrations provided through FIGS. 5-8 are related to the same exemplary customer (Mr. Holmes) for the purpose of easier understanding. In FIG. 6, it may be noted that the vendor does not have any information about this customer other than the blockchain transaction ID retrieved from the public blockchain. Herein, the vendor may request permission to view one or more sensitive data from the customer by selecting them and requesting for permission as depicted in illustration 700 of FIG. 7. Herein, the vendor is requesting permission from the customer to access the customer's name, address, and phone number. Once the vendor sends a request to access this information, the customer may receive a notification to allow/deny permission. Allowing the request means the conditions for executing the smart contract are met, the smart contract is executed to alter the view permission provided for that particular vendor. Alternatively, denying the request means the conditions for executing the smart contracts are not met and the view permissions do not change for the vendor.

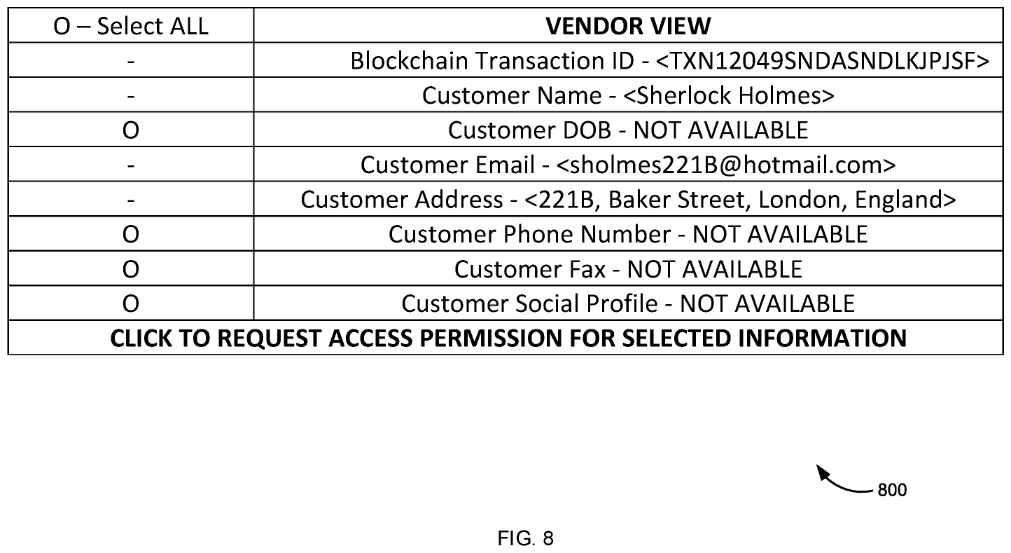

FIG. 8 is an exemplary illustration 800 of an updated view from a vendor's perspective after a customer provides access to requested information via the secure data access platform 102. Herein, the vendor requested for permission to view a subset of data as depicted in FIG. 7 and the customer approves this requests thereby validating the conditions for execution of the smart contract. This changes the access permission of the vendor with respect to the particular customer thereby allowing the vendor to view/access the requested information as depicted in FIG. 8.

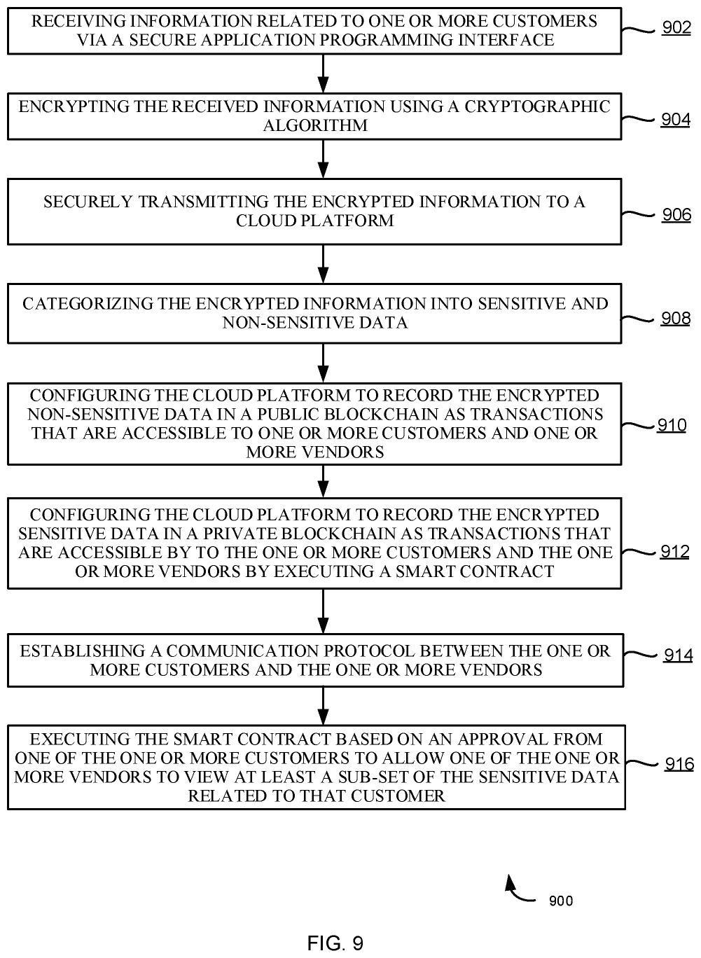

FIG. 9 is an example flow diagram 900 of a method for providing secure data access control mechanism using distributed ledgers. The process depicted in FIG. 9 represents generalized illustrations, and that other processes maybe added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions, to change states, and/or to make decisions. Alternatively, the processes may represent functions and/or actions performed by functionally equivalent circuits like analog circuits, digital signal processing circuits, application-specific integrated circuits (ASICs), or other hardware components associated with the system. Furthermore, the flow charts are not intended to limit the implementation of the present application, but rather the flowcharts illustrate functional information to design/fabricate circuits, generate programs, or use a combination of hardware and program to perform the illustrated processes.

At 902, the method performs the step of receiving information related to one or more customers via a secure application programming interface. At 904, the method performs the step of encrypting the received information using a cryptographic algorithm. At 906, the method performs the step of securely transmitting the encrypted information to a cloud platform. At 908, the method performs the step of categorizing the encrypted information into sensitive and non-sensitive data. At 910, the method performs the step of configuring the cloud platform to record the encrypted non-sensitive data in a public blockchain as transactions that are accessible to one or more customers and one or more vendors. At 912, the method performs the step of configuring the cloud platform to record the encrypted sensitive data in a private blockchain as transactions that are accessible by the one or more customers and the one or more vendors by executing a smart contract. At 914, the method performs the step of establishing a communication protocol between the one or more customers and the one or more vendors. At 916, the method performs the step of executing the smart contract based on an approval from one of the one or more customers to allow one of the one or more vendors to view at least a sub-set of the sensitive data related to that customer.

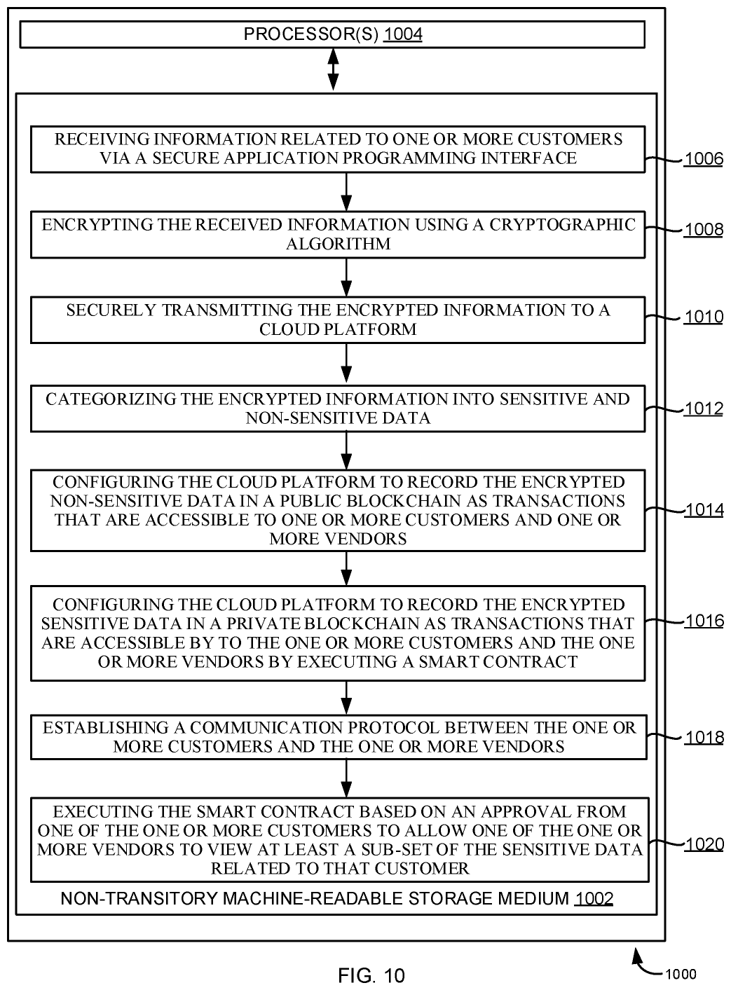

FIG. 10 is a block diagram 1000 of an example computing system including instructions stored in a machine-readable storage medium 1002 for providing secure data access control mechanism using distributed ledgers. The computing system 1000 may include a processor(s) 1004 and a non-transitory machine-readable storage medium 1002 communicatively coupled through a system bus. The processor 1004 may be any type of central processing unit (CPU), microprocessor, or processing logic that interprets and executes machine-readable instructions stored in the machine-readable storage medium 1002. The machine-readable storage medium 1002 may be a random-access memory (RAM) or another type of dynamic storage device that may store information and machine-readable instructions that may be executed by the processor 1004. For example, the machine-readable storage medium 1002 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, the machine-readable storage medium 1002 may be a non-transitory machine-readable medium. In an example, the machine-readable storage medium 1002 maybe remote but accessible to computing system 1000.

At 1006, the machine-readable storage medium instructs the system to receive information related to one or more customers via a secure application programming interface. At 1008, the machine-readable storage medium instructs the system to encrypt the received information using a cryptographic algorithm. At 1010, the machine-readable storage medium instructs the system to securely transmit the encrypted information to a cloud service platform. At 1012, the machine-readable storage medium instructs the system to categorize the encrypted information into sensitive and non-sensitive data. At 1014, the machine-readable storage medium instructs the system to configure the cloud platform to record the encrypted non-sensitive data in a public blockchain as transactions that are accessible to one or more customers and one or more vendors. At 1016, the machine-readable storage medium instructs the system to configure the cloud platform to record the encrypted sensitive data in a private blockchain as transactions that are accessible by to the one or more customers and the one or more vendors by executing a smart contract. At 1018, the machine-readable storage medium instructs the system to establish a communication protocol between the one or more customers and the one or more vendors. At 1020, the machine-readable storage medium instructs the system to execute the smart contract based on an approval from one of the one or more customers to allow one of the one or more vendors to view at least a sub-set of the sensitive data related to that customer.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While secure storage and management of information is the primary objective of the present disclosure, the advantages of the solution provided herein extend beyond this objective. Data protection laws and privacy laws around the world are being strictly enforced in the recent years this has led to many businesses struggling to meet compliance standards. Many a times, businesses are accused of accessing the personal information of customers even if it was due to the customer's ignorance. Customers often skip privacy policies and data access-related policy documents and clauses while using services either due to ignorance or due to the complexity of these documents. With the solution provided by the present disclosure, each and every transaction performed by the customer as well as the vendor (including information transfer as well as request to initiate information transfer) are recorded by the platform as blockchain transactions. These records are permanently stored and cannot be easily manipulated thereby providing transparency to the services related to information exchange. If any conflicts arise with respect to data breach, these transactions may be presented as evidence to back the claims of the vendor/customer. Thus, the present solution provides a robust and distributed mechanism for recording historical details related to information exchange by multiple stakeholders involved in a business transaction.

In another embodiment of the present disclosure, the platform regularly monitors the connection status between the blockchain network and the secure data access management platform/cloud platform. In many scenarios, blockchain networks tend to act in unexpected ways thereby causing connection errors. To avoid such scenarios, the platform disclosed herein regularly checks for heartbeat signals from the blockchain.

In another embodiment of the present disclosure, the monitor the connection status between the blockchain and the platform, the platform regularly runs test scripts (such as test writes) at fixed time intervals to the blockchain network. If an error occurs during such writes, the platform either alerts an administrator regarding the same or takes counteraction to rectify the error in connection. The techniques presented herein may identify connection errors caused due to scenarios such as a change in connection protocols, change in credentials (ex: caused due to soft fork, creating new endpoint), updates to consensus mechanism, and the like.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method for providing a secure data access control mechanism using blockchains, comprising:
receiving information related to one or more customers via a secure application programming interface;
encrypting the received information using a cryptographic algorithm;
securely transmitting the encrypted information to a cloud platform;
categorizing the encrypted information into sensitive and non-sensitive data;
configuring the cloud platform to record the encrypted non-sensitive data in a public blockchain as transactions that are accessible to one or more customers and one or more vendors;
configuring the cloud platform to record the encrypted sensitive data in a private blockchain as transactions that are accessible by to the one or more customers and the one or more vendors by executing a smart contract;
establishing a communication protocol between the one or more customers and the one or more vendors; and
executing the smart contract based on an approval from one of the one or more customers to allow one of the one or more vendors to view at least a sub-set of the sensitive data related to that customer.

2. The method of claim 1, wherein one of the one or more customers approve execution of the smart contract to allow one of the one or more vendors to view the sub-set of sensitive data related to that customer upon receiving a request from that vendor.

3. The method of claim 1, wherein one of the one or more customers approve execution of the smart contract to allow one of the one or more vendors to view the sub-set of sensitive data related to that customer without receiving any request from the vendor.

4. The method of claim 1, wherein the non-sensitive data recorded in the public blockchain can be accessed using a blockchain transaction ID.

5. The method of claim 1, wherein the sensitive data recorded in the private blockchain can be accessed by using a private key.

6. The method of claim 1, wherein at least one of the one or more customers can toggle the visibility of at least one of the one or more vendor's visibility of a sub-set or whole of the sensitive data related to that customer by executing the smart contract in the private blockchain.

7. The method of claim 1, wherein transaction IDs related to each blockchain transactions are stored in the cloud platform.

8. The method of claim 1, further comprising:
configuring the cloud platform to monitor heartbeat signals from the blockchain at defined time intervals to validate the connection between the blockchain and the cloud platform.

9. A system comprising:
at least one processor; and
at least one non-transitory computer readable storage medium storing instructions thereon that, when executed by the at least one processor, cause the system to:
receive information related to one or more customers via a secure application programming interface;
encrypt the received information using a cryptographic algorithm;
securely transmit the encrypted information to a cloud platform;
categorize the encrypted information into sensitive and non-sensitive data;
configure the cloud platform to record the encrypted non-sensitive data in a public blockchain as transactions that are accessible to one or more customers and one or more vendors;
configure the cloud platform to record the encrypted sensitive data in a private blockchain as transactions that are accessible by to the one or more customers and the one or more vendors by executing a smart contract;
establish a communication protocol between the one or more customers and the one or more vendors; and
execute the smart contract based on an approval from one of the one or more customers to allow one of the one or more vendors to view at least a sub-set of the sensitive data related to that customer.

10. The system of claim 9, wherein one of the one or more customers approve execution of the smart contract to allow one of the one or more vendors to view the sub-set of sensitive data related to that customer upon receiving a request from that vendor.

11. The system of claim 9, wherein one of the one or more customers approve execution of the smart contract to allow one of the one or more vendors to view the sub-set of sensitive data related to that customer without receiving any request from the vendor.

12. The system of claim 9, wherein at least one of the one or more customers can toggle the visibility of at least one of the one or more vendor's visibility of a sub-set or whole of the sensitive data related to that customer by executing the smart contract in the private blockchain.

13. The system of claim 9, further cause the system to:
configure the cloud platform to monitor heartbeat signals from the blockchain at defined time intervals to validate the connection between the blockchain and the cloud platform.

14. A non-transitory computer readable medium storing instructions thereon that, when executed by at least one processor, cause a computer system to:
receive information related to one or more customers via a secure application programming interface;
encrypt the received information using a cryptographic algorithm;
securely transmit the encrypted information to a cloud platform;
categorize the encrypted information into sensitive and non-sensitive data;
configure the cloud platform to record the encrypted non-sensitive data in a public blockchain as transactions that are accessible to one or more customers and one or more vendors;
configure the cloud platform to record the encrypted sensitive data in a private blockchain as transactions that are accessible by to the one or more customers and the one or more vendors by executing a smart contract;
establish a communication protocol between the one or more customers and the one or more vendors; and
execute the smart contract based on an approval from one of the one or more customers to allow one of the one or more vendors to view at least a sub-set of the sensitive data related to that customer.

15. The non-transitory computer readable medium of claim 14, wherein one of the one or more customers approve execution of the smart contract to allow one of the one or more vendors to view the sub-set of sensitive data related to that customer upon receiving a request from that vendor.

16. The non-transitory computer readable medium of claim 14, wherein one of the one or more customers approve execution of the smart contract to allow one of the one or more vendors to view the sub-set of sensitive data related to that customer without receiving any request from the vendor.

17. The non-transitory computer readable medium of claim 14, wherein at least one of the one or more customers can toggle the visibility of at least one of the one or more vendor's visibility of a sub-set or whole of the sensitive data related to that customer by executing the smart contract in the private blockchain.

18. The non-transitory computer readable medium of claim 14, further cause the computer system to:
configure the cloud platform to monitor heartbeat signals from the blockchain at defined time intervals to validate the connection between the blockchain and the cloud platform.
